(19) United States
(12) Patent Application Publication
(10) Pub. No.: US 2004/0128205 A1
(43) Pub. Date: Jul. 1, 2004

(54) Automated, interconnected process for ordering products

(76) Inventors: K. Michael Lanham, Midland, MI (US); Anna Marie Reuhl, Midland, MI (US); Joseph Donald Sheets II, Midland, MI (US)

Correspondence Address: DOW CORNING CORPORATION, 2200 W. SALZBURG ROAD, P.O. BOX 994, MIDLAND, MO, 48686-0994, US

(21) Appl. No.: 10/334,058

(22) Filed: Dec. 30, 2002

(51) Int. Cl. G06F 17/60

(52) U.S. Cl. 705/26

(57) ABSTRACT

An automated process for making products available for sale using a communications network made accessible to customers in which the on-line customer interface is in real time communication with the manufacturer's enterprise resource planning software which provides selected shipping units and production lead time data for the desired products.

### BACKGROUND OF THE INVENTION

This invention relates to a product ordering process, and more specifically, to a process for making products available by a seller of products and a process for the customer of the products to view the terms of sale for products, both using an electronic communication network. The process is especially useful for ordering industrial products from the manufacturer thereof over the Internet.

Many processes exist for ordering products including those used by consumers and those used in industry. These include, for example, traditional processes whereby goods, as well as their terms and conditions for purchase, are physically reviewed and ordered. These traditional processes also include processes whereby goods are reviewed in catalogues and ordered by, for example, mail or telephone, under the terms and conditions recited therein.

Advances in computers and other related electronic media (e.g., the Internet, local area networks of computers and the like) resulted in a variety of new electronic, on-line order entry and processing techniques. These include, for example, consumer on-line purchases for a wide range of goods (for example, from books, to sporting goods, to travel reservations). In the industrial arena, many companies order products though a variety of business-to-business (B2B) systems and software using a variety of methods.

Numerous patents have described such processes. These include, for example, U.S. Pat. Nos. 4,992,940, 5,666,493, 5,765,132, 5,786,142, 5,870,717, 5,895,454, 5,970,472, and 6,282,518.

As the order entry process progressed with computerization, so, too, did the business environment. For example, computer systems are now used to automate processes, manage large quantities of information, provide fast, flexible communications, and manage business environments. These computer systems include enterprise resource planning software such as that supplied by the SAP® company which has allowed for computerization of processes such as billing, order-taking, order processing, invoice validation, scheduling, inventory control, record keeping, financial accounting, planning, and related managerial control, production planning and control, project accounting, planning, and control and the like.

To date, however, the order entry systems used by customers and the business systems used by sellers generally do not communicate adequately. Accordingly, the integration of these systems may require a human interface to receive the order from the customer and enter it into the business system or other human intervention in the process. This human intervention has, thus, not only slowed the process, but it has allowed the possibility for error and inconsistency in applying business rules. Moreover, may be able to obtain a minimal level of inventory information (such as whether or not a product is in stock), but are generally not able to determine certain other possibly critical information within the seller's business systems such as logical and efficient shipping units and production lead times for selected products.

What is needed is the ability for a customer, in the order entry and processing process, to directly query certain of the manufacturer's business data to arrive at a purchase decision.

### SUMMARY OF THE PRESENT INVENTION

The present invention provides a new and improved process for making products available for sale using a communications network made accessible to customers. The process comprises the seller generating at least the selected shipping units and production lead times for selected products using enterprise resource planning software and making such information available for customer query. The customer effects a connection through the communications network to the information containing at least the selected shipping units and production lead times on the selected products. The customer effecting a query for at least 1 product. The seller automatically responds to the customer query by providing at least the information related to said product's selected shipping units and production lead times generated by the enterprise resource planning software and the price per the selected shipping unit over the communications network. In a preferred embodiment, the customer can place an order for the product with the seller

The present invention also provides a process for making products available for sale using a communications network made accessible to customers. The process comprises generating at least the selected shipping units and production lead times for selected products using enterprise resource planning software and making said information available for customer query. Then, when a customer queries a product, automatically responding by providing at least the information related to said product's selected shipping units and production lead times generated by the enterprise resource planning software and the price per the selected shipping unit over the communications network.

The present invention also provides a process for viewing the terms of sale for products available over a communications network. The process comprises a customer effecting a connection through a communications network to a seller of products who has generated information comprising at least the selected shipping units and production lead times for said products using enterprise resource planning software and made said information on said products available to said customer. The customer effects a query for at least 1 product and receives information related to said product's selected shipping units, production lead times and the price per the logical and efficient shipping unit.

This process provides for an efficient method of ordering products on-line. It also allows for the seller to have real-time, on-line pricing.

### BRIEF DESCRIPTION OF THE DRAWINGS

FIG. 1 is a block diagram of a computer network suitable for carrying out the process of the present invention.

FIG. 2 is a block diagram of the steps in the operation of the process of the present invention.

### DETAILED DESCRIPTION OF THE INVENTION

The present invention relates to a new and improved process for making products available for sale using a communications network made accessible to customers. As used herein, the term ‘automated’ means that the process is one which operates by electronic means with little or, preferably, no human intervention on the part of the seller of the products. The term ‘on-line’ is used herein to mean that the communication is carried out over an electronic communications network such as a telephone system or, preferably, a computer network. More preferably, the on-line communications network is the Internet.

The process of the invention may start by the seller of products selecting which products will be made available to customers on-line through the communications network. It should be noted that the term “seller” as used herein can include, but is not limited to, the manufacturer of the goods, a representative of the manufacturer's goods, a party contracting to sell the goods for another party, a party in a similar arrangement that will distribute the goods of another, and the like. The seller may choose to offer all its products for on-line ordering or, alternatively, the seller may choose to only offer a subset thereof. When only a subset is to be offered, the seller may make this selection based on, for example, sales criteria such as volume, cost, time to shipping, delivery time, availability and the like.

In a preferred embodiment of the invention where the seller is the manufacturer and the products are industrial or commercial-grade products, the seller may additionally use selection criteria such as manufacturing capacity, production lead times, type of products, and the like.

In an alternative embodiment, the seller uses the process of the present invention as a representative of the manufacturer.

The next step in the process of the invention is for the seller to generate at least the selected shipping units and lead times for the selected products. As used herein, the 'selected shipping units' are those units of a product in which the seller will sell said products to a customer. The selected shipping units are preferably logical and efficient shipping units in that they are typically a standard quantity of products that the seller can quantify and use for planning while, at the same time, render the manufacture, sales and/or distribution processes for the products efficient. In a preferred embodiment of the invention where the seller is the manufacturer and the products are industrial products, the selected logical and efficient shipping unit is typically a standard quantity of products that the seller can efficiently manufacture, sell and distribute within the production lead time pursuant to an order by a customer.

The selected units are desirable from several standpoints. For example, if the seller is the manufacturer, it allows for planning in the production process. Specifically, when production capacity and the shipping units are both known, it allows for the calculation of maximum production of shipping units and, thus, the maximum quantity that can be sold and delivered over a period of time. Likewise, the production capacity and utility as well as shipping units also allow for the calculation of shipment date, delivery times and terms to be used in the sales and upstream planning for production factors such as labor, raw material, and equipment. Additionally, the shipping units can be selected and/or standardized to allow for the greatest efficiency in the production, shipment and/or delivery of the products to the customer. Moreover, utilizing selected shipping units allow a global manufacturer of goods to have global capacity leveling. In addition, utilizing selected shipping units can optimize freight costs by, for example, optimizing resources (e.g., full trucks, efficient use of human resource, etc.) and the ability to meet packets of demand. Finally, utilizing selected shipping units allow for accurate planning of the production lead times for the manufacture's and customer's planning.

It should be noted that if the seller is not the manufacturer of the goods, the seller can provide the above optimized information to the manufacturer to derive these same benefits.

In the past, the selected shipping units and lead times were often estimated by manually collecting the various pieces of information that were necessary for the estimation and compiling them to produce the desired data. This process, however, was inefficient and often unreliable. In a modern manufacturing environment, however, this can be accomplished using enterprise resource planning software. Such software can either be programmed for a specific situation or, as is most often the case, the software can be purchased form a variety of vendors. Examples of commercially available software include that provide by Oracle™, Siebel™, Baan™, BPICS™, or SAP™. When appropriately configured, this software has the capability of automating and planning for an entire organization. For example, in a manufacturing environment, this software can plan for ordering of raw materials, schedule production, manage product data, monitor sales, handle human resources, manage order-taking, manage order processing, validate invoices, manage billing, keep records, perform standard accounting, and the like. As used in this invention, however, ‘enterprise resource planning software’ is meant to include any software that can automatically provide at least the standard shipping units and production lead times for products in a manufacturing environment.

The ability to provide production lead times is also desirable. As used herein, the “production lead time” is the time period from placing the order to the time of product shipment or delivery. This is important in that the manufacturer and the customer are both able to plan their resources to meet the order timing. This was not as critical an issue when manufactures maintained substantial inventory to meet demand and, as such, little effort was expended to calculate such times. In today's “just in time production” environment, however, such production lead times can be a critical element and accurate information is often necessary.

Accordingly, by generating and using the standard shipping units and production lead times in the process described herein, one is able to decrease inventory and have better capacity utilization.

Once at least the standard shipping units and production lead times are generated, this information as well as other sales criteria are made available for customer query. This can be accomplished by, for example, allowing the customer to query data made available in the form of lists, databases, catalogues or the like. In a preferred embodiment of the invention, the customer is allowed to query the relevant information directly available in the seller's enterprise resource planning software. This is typically accomplished by using software specifically designed for this purpose. Such software is available, for example, from companies such as HAHT™.

To obtain the product, the customer effects a connection through the communications network to the information containing at least the standard shipping units and lead times on the selected products. The method of effecting this connection depends on the communications network selected. For example, the customer may dial into a telephone network or log onto an Internet site. The communications network may be made available to the general public or, if desired, the site may be restricted to only selected customers as, for example, in the case of industrial products. Method for restriction include, for example, requiring customers to log into an intranet site using a set of security measures such as passwords. This protected access can be implemented over a private computer network or over a public network such as the Internet using any of a number of well known security approaches such as a VPN.

Upon making the connection, the customer may also receive other information pertinent to the transaction. For example, the customer may receive information on price, terms and conditions of the transaction, delivery dates, restrictions on sale and the like.

It should be noted that the customer may effect the connection to the communication network and/or perform some or all of the subsequent steps in the process of this invention with human intervention or automatically. For example, a representative of the customer may effect the connection to the communications network, query a product, and place the order. Alternatively, this may be done in an automated or semi-automated fashion. For example, the customer's enterprise planning software may be directly linked to the seller's enterprise planning software such that when the customer's stock level of a product reaches a certain minimum threshold level, the transaction between the seller and the customer is completed in an automated fashion.

Once the customer effects the connection to the communication network, the customer usually effects a query for the product or products desired. Typically, this is accomplished by, for example, the customer selecting the desired product from a list or compilation of products that the seller decided to make available for on-line ordering.

In response to the customer query, the seller automatically responds over the communications network. As noted above, the seller's response is typically without human intervention and can be facilitated by software such as the seller's enterprise planning software and/or the software that facilitates communication with the seller's enterprise planning software.

The seller's response to the query can include any information deemed necessary, desirable or relevant to conclude the transaction. Typically, this will include information such as the product's standard shipping units and production lead times generated by the enterprise resource planning software and the price per the standard shipping unit. Also included will likely be the terms and conditions under which the transaction will be concluded.

Once the customer has reviewed the relevant data provided and determined that a purchase will occur, the customer places an order for the product with the seller. This can be accomplished by any desirable means such as, for example, the on-line method of putting the goods in a cart, the on-line method of clicking on a good to be purchased followed by entering necessary information such as quantity and delivery date, a telephonic means of selecting the desirable goods, calling a representative of the seller, a response to a manufacturer's query if the customer desires to purchase the products, or the like.

It should be noted that the order receipt by the seller can be, and preferably is, also automated such that the order is automatically transferred, for example, through the enterprise resource planning software to the production process. Alternatively, however, a minimal amount of human intervention may be used, for example, to receive the order from the customer and plan for its manufacture and/or shipment.

Once the order is placed, the remaining typical steps in an order transaction process are completed. For example, if the goods are available, the seller ships under the terms of the transaction, invoices the customer and the customer pays for the transaction. Alternatively, if the seller is also the manufacturer and the products are not available in stock, the products are manufactured, the seller ships under the terms of the transaction, invoices the customer and the customer pays for the products. Again, these steps may be automated or there may be human intervention. In a preferred process of the invention, the customer placing the order and/or the production of the product automatically initiates a series of transactions related to the sale. For example, placing the order could automatically generate an e-mail or letter that confirms the order. Likewise, production and/or shipment of the product could automatically generate an e-mail or letter that indicates the date of shipment, provides a manufacturers safety data sheet (electronically or in writing), confirms date of arrival, sends the invoice, and/or the like.

The process of the invention can also incorporate other features. For example, the method can also allow the customer to choose deviations from the standard terms. For example, a preferred process of the invention would allow the customer to choose a better shipment date or delivery date (e.g., alter the standard production lead time) for an increased price. Similarly, the customer could choose altered payment terms (e.g., longer payment terms) at an increased price. Likewise, the process of the invention can automatically validate a customer's credit at a credit rating agency prior to accepting the order or, alternatively, deny or modify a customer's ability to place an order if certain criteria are not met (e.g., outstanding invoices).

In addition, a preferred process of the invention can incorporate other substantial improvements such as the ability to change an order once placed, to automatically identify customer ship to locations based on the purchaser's information, to automatically allocate the sale to the appropriate entity (e.g., geographic area) of the seller, to automatically allocate the appropriate manufacturing and/or shipping location, and the like.

This process has a number of advantages over alternative systems. For example, the process is essentially automated so that there is little or no human intervention. This allows for efficient ordering and minimizes the potential for errors due to human intervention. Similarly, the process does not allow for variation in applying certain business rules of the seller and, thus, inconsistent, non-reproducible, and ineffective business management. Likewise, the process of the invention allows for volume based pricing and dynamic pricing as sales conditions change.

Finally, this process can be practiced by the manufacturer of the goods or it can be practiced by an agent of the manufacturer. For example, one party could choose to include the goods of another party (e.g., a manufacturer) on its website using the process of the invention.

The present invention will now be described more fully with reference to the accompanying drawings, in which the preferred embodiments of the invention are shown. This invention may, however, be embodied in many different forms and should not be construed as limited to the embodiments set forth herein. Rather, these embodiments are provided so that this disclosure will be thorough and complete.

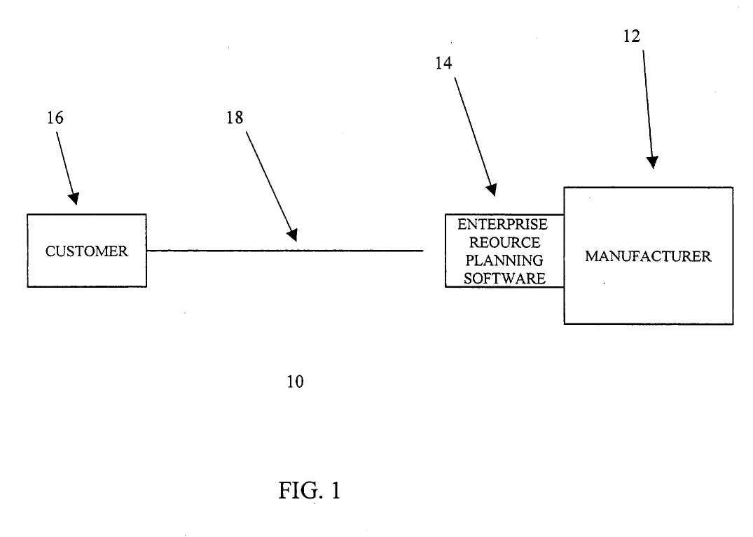

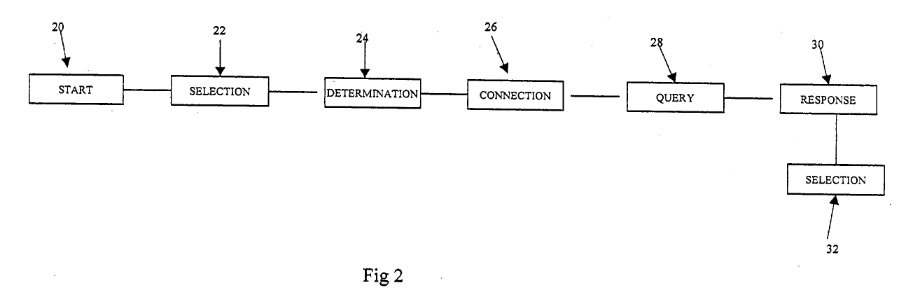

The present invention will now be described using the block diagrams of FIGS. 1 and 2. It will be understood that each element of the illustrations, and combinations of elements in the illustration can be implemented by general and/or special purpose hardware-based systems that perform the specified functions or steps, or by combinations of general and/or special purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer implemented process such that the instructions which execute on the processor provide steps for implementing the functions specified in the illustrations. Accordingly, FIGS. 1 and 2 support combinations of means for performing the specified functions, combinations of steps for performing the specified functions and program instruction means for performing the specified functions.

Reference will now be had to the drawing, and more particularly to FIG. 1 thereof, for a description of the process, generally designated by the reference numeral 10 in FIG. 1, for an automated process for ordering products using a communications network made accessible to customers therefor. As shown in FIG. 1 of the drawings, the principal elements of the process 10 are the seller, in this case a manufacturer of the products, generally designated by the reference numeral 12 in FIG. 1, the enterprise resource planning software, generally designated by the reference numeral 14 in FIG. 1, the customer, generally designated by the reference numeral 16 in FIG. 1, and the communications network, in this case Internet generally designated by the reference numeral 18 in FIG. 1.

FIG. 2 shows the steps in the operation of the process 10 in accordance with the present invention. The process steps begin at the box designated by the reference numeral 20 labeled “START”. In the first step thereafter as denoted by the box labeled “SELECTION” (22) is the selection by the manufacturer 12 of the products to be made available to customers 16 on-line over the Internet. The products that are selected by the manufacturer 12 comprise a subset of the manufacturer's products.

In the next step of the invention as denoted by box 24, labeled “DETERMINATION”, the manufacturer 12 determines the standard shipping units and the production lead times using the enterprise resource planning software 14.

In the next step in the process labeled CONNECTION (26) the customer 16 effects a connection through the Internet 18 to the information containing at least the standard shipping units and production lead times on the selected products in the manufactures enterprise resource planning software 14.

The next step in the process of the invention, identified in FIG. 2 as box 28 labeled QUERY, is for the customer to effect a query for at least 1 product.

In the next step of the process 10, identified as box 30 labeled RESPONSE, the manufacturer responds to the customer query without human intervention by providing at least the information related to said product's standard shipping units and production lead times generated by the enterprise resource planning software and the price per the standard shipping unit over the Internet 18.

In the final step in the process of the invention, identified as box 32 labeled ORDER, the customer 16 places an order with the manufacturer 12 for the product over the Internet.

While several embodiments of our invention have been shown and/or alluded to herein, it will be appreciated that modifications thereof, some of which have been alluded to hereinabove, may still be readily made thereto by those skilled in the art. We, therefore, intend by the appended claims to cover the modifications alluded to herein as well as all the other modifications which fall within the true spirit and scope of our invention.

What is claimed is:

1. A process for making products available for sale using a communications network made accessible to customers, the process comprising:
a. generating at least the selected shipping units and production lead times for selected products using enterprise resource planning software and making such information available for customer query;
b. the customer effecting a connection through the communications network to the information containing at least the selected shipping units and production lead times on the selected products;
c. the customer effecting a query for at least 1 product; and
d. automatically responding to the customer query by providing at least the information related to said product's selected shipping units and production lead times generated by the enterprise resource planning software and the price per the selected shipping unit over the communications network.

2. The process of claim 1 further comprising (e) the customer placing an order for the product with the seller.

3. The process of claim 2 further comprising (f) the seller receiving the order and automatically transferring it to the enterprise resource planning software where it is scheduled for production.

4. The process of claim 3 further comprising (g) the seller manufacturing the product and shipping it to customer.

5. The process of claim 1 wherein the on-line communications network is the Internet.

6. The process of claim 1 wherein the product is an industrial product.

7. The process of claim 5 wherein the seller is the manufacturer of the industrial product.

8. The process of claim 5 wherein the seller is not the manufacturer of the industrial product.

9. The process of claim 1 wherein the selected shipping units and production lead times for the selected products are made available for customer query via the customer querying the seller's enterprise resource planning software.

10. The process of claim 2 wherein the customer placing the order automatically generates a communication that acknowledges the order.

11. The process of claim 4 wherein the seller shipping the product automatically generates a communication that indicates the date of shipment, provides a manufacturer's safety data sheet or sends the invoice.

12. The process of claim 2 wherein the customer can automatically choose a shipment date prior to the standard production lead time for an increased price.

13. The process of claim 2 wherein the customer can automatically choose payment terms other than the standard payment terms for an increased price.

14. The process of claim 2 wherein the seller automatically validates the customer's credit.

15. The process of claim 2 wherein the seller automatically checks the customer's prior orders to determine if the order should be accepted.

16. The process of claim 2 wherein the seller's selling entity, manufacturing entity or shipping location are automatically determined.

17. A process for making products available for sale using a communications network made accessible to customers, the process comprising:
a. generating at least the selected shipping units and production lead times for selected products using enterprise resource planning software and making said information available for customer query; and
b. automatically responding to a customer query regarding a product by providing at least the information related to said product's selected shipping units and production lead times generated by the enterprise resource planning software and the price per the selected shipping unit over the communications network.

18. The process of claim 17 further comprising (c) receiving an order and automatically transferring it to the enterprise resource planning software where it is scheduled for production.

19. The process of claim 18 further comprising (d) manufacturing the product and shipping it to the customer.

20. The process of claim 18 wherein receiving the order automatically generates a communication that acknowledges the order.

21. The process of claim 19 wherein shipping the product automatically generates a communication that indicates the date of shipment, provides a manufacturer's safety data sheet or sends the invoice.

22. The process of claim 18 wherein receiving the order initiates a process of customer's credit validation.

23. The process of claim 18 wherein receiving the order initiates a process of checking the customer's prior orders to determine if the order should be accepted.

24. The process of claim 18 wherein receiving the order initiates a process wherein the seller's selling entity, manufacturing entity or shipping location are automatically determined.

25. A process for viewing the terms of sale for products available over a communications network, the process comprising:
a. a customer effecting a connection through a communications network to a seller of products who has generated information comprising at least the selected shipping units and production lead times for said products using enterprise resource planning software and made said information on said products available to said customer; and
b. the customer effecting a query for at least 1 product and receiving information related to said product's selected shipping units, production lead times and the price per the standard shipping unit.

26. The process of claim 25 further comprising (c) the customer placing an order for the product with the seller.

27. The process of claim 25 wherein the customer can choose a shipment date prior to the standard production lead time for an increased price.

28. The process of claim 25 wherein the customer can choose payment terms other than the standard payment terms for an increased price.
